(19) United States
(12) Patent Application Publication
(10) Pub. No.: US 2024/0087048 A1
(43) Pub. Date: Mar. 14, 2024

(54) System for Dissemination of Sensitive Information

(71) Applicant: Henry L. Bolton, Fernandina Beach, FL (US)

(72) Inventor: Henry L. Bolton, Fernandina Beach, FL (US)

(21) Appl. No.: 18/513,472

(22) Filed: Nov. 17, 2023

Related U.S. Application Data
(63) Continuation-in-part of application No. 17/888,173, filed on Aug. 15, 2022.
(60) Provisional application No. 63/232,649, filed on Aug. 13, 2021.

(51) Int. Cl. G06Q 40/12

(52) U.S. Cl. CPC G06Q 40/123

(57) ABSTRACT

A system for disseminating sensitive information comprises a software application which enables a user to capture images, via a camera provided by the mobile device, of one or more documents which can be subsequently uploaded to a remote database. The software application comprises an artificial intelligence (AI) module which further comprised of a document evaluation component, a document validation component and a document summarization component, and an external communication module. The document evaluation component identifies one or more notice letters and determines a document checklist. The document validation component may cross-reference consistency of certain personal information in one or more documents. The document summarization component may identify the purpose of the notice letters and summarize the notice letters. The external communication module may allow the user to electronically transmit selected files to another party via an electronic facsimile (E-Fax).

### CROSS-REFERENCE TO RELATED APPLICATIONS

This application is a continuation-in-part of U.S. patent application Ser. No. 17/888,173, filed on Aug. 15, 2022, which claims the benefit of the filing date under 35 U.S.C. § 119(e) of Provisional Patent Application Ser. No. 63/232,649, filed on Aug. 13, 2021, each of which is hereby incorporated by reference in its entirety.

### FIELD OF THE INVENTION

The present invention comprises a system for disseminating sensitive information. The system for disseminating sensitive information is generally related to mobile applications which assist with the aggregation and dissemination of one or more types of data.

### BACKGROUND

Each year hundreds of thousands of U.S. individuals are audited. An auditor often requires a variety of documents and information to be submitted for review. Being audited can be a stressful process for the individual being audited. The auditor typically notifies the individual being audited with a notice letter. The notice letter includes general information about the audit, what information is being requested, and how to submit the requested information. However, if the notice letter is misplaced or if the individual being audited does not carefully and thoroughly review the standardized letter the audit process can become unnecessarily extended and result in additional costs to the individual being audited. Accordingly, what is needed is a system which allows individuals being audited to conveniently aggregate copies of various documents and paperwork which are typically requested during the audit process.

### BRIEF SUMMARY OF THE INVENTION

The present disclosure describes a system for disseminating sensitive information. The system comprises a software application, a mobile device, a network, a remote database, and one or more documents. The one or more documents may comprise permanent documents, one or more temporary documents, one or more tax returns, and one or more notice letters received from another party which may contain sensitive personal information. The software application, which comprises a mobile application and, optionally, a web-based application. The software application comprises an artificial intelligence (AI) module, and an external communication module. The AI module further comprises a document evaluation component, a document validation component, a document summarization component, a letter generation component, a guidance component, and an extraction component.

The software application is installed on the mobile device, which includes a camera, and is configured to allow the user to access the camera to capture one or more image files of the one or more documents and then upload one or more image files to the remote database. The software application may also be configured to enable a user to upload one or more electronic files to the remote database. The one or more electronic files may comprise a variety of file types, including image files. It is anticipated that the software application may automatically create duplicates of each of the uploaded electronic files and then subsequently convert each duplicate file into a text-readable file. It is anticipated that the software application may be further configured to allow the user to optionally convert one or more types of electronic files into a portable document format (PDF).

The document evaluation component may evaluate the one or more tax returns and the one or more notice letters, and in response, determining a document checklist. The document checklist provides a list of one or more documents that pertain to information requested within the notice letter that the user received from an auditor. The document checklist includes a visual indicator adjacent to each of the one or more documents and visually signifies if the corresponding document has been properly uploaded to the remote database. The document validation component of the AI module may be configured to confirm if an electronic copy of each of the one or more documents enumerated in the document checklist have been uploaded to the remote database. The document validation component may also be configured to cross-reference if certain sensitive personal information is consistently disclosed within each of the one or more documents uploaded to the remote database. The document summarization component is configured to identify purpose of the notice letter and summarize the notice letter. In response to identifying the purpose of the notice letter, the letter generation component is configured to generate a response letter, and the guidance component is configured to generate procedural steps. In addition, the extraction component maybe configured to extract certain personal information from the one or more text-readable files and generate the certain personal information on the response letter.

The external communication module is configured to allow a user to conveniently select one or more electronic files which have been uploaded to the remote database and electronically transmit the selected electronic files to another party. Additionally, the external communication module is configured to transmit one or more reminder notifications to the user if one or more electronic copies of the one or more documents have not been uploaded by a predetermined date. The external communication module allows the user to electronically transmit, via email or electronic facsimile (E-Fax), one or more of the one or more electronic files to one or more other parties.

### BRIEF DESCRIPTION OF THE DRAWINGS

FIG. 1 is a schematic diagram of a system for disseminating sensitive information.

FIG. 2 is a schematic flowchart illustrating how a user of the system for disseminating sensitive information accesses their respective user account.

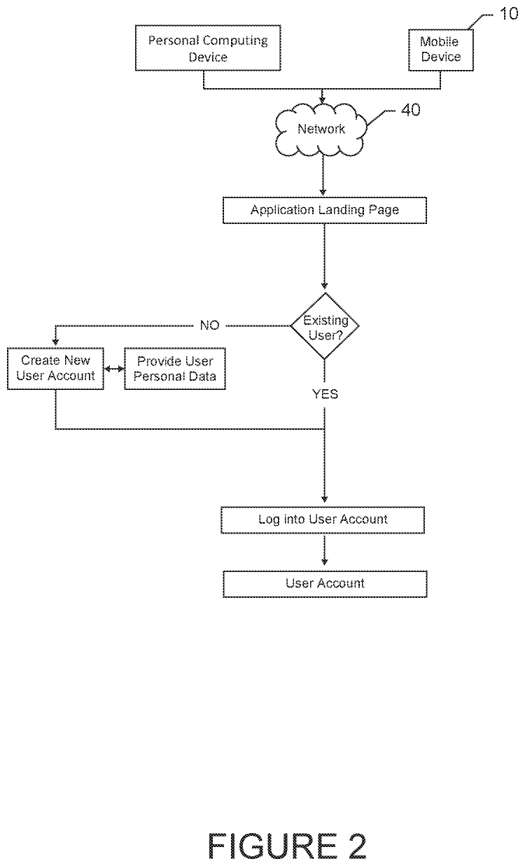

FIG. 3 is a schematic diagram of a user account provided by the system for disseminating sensitive information.

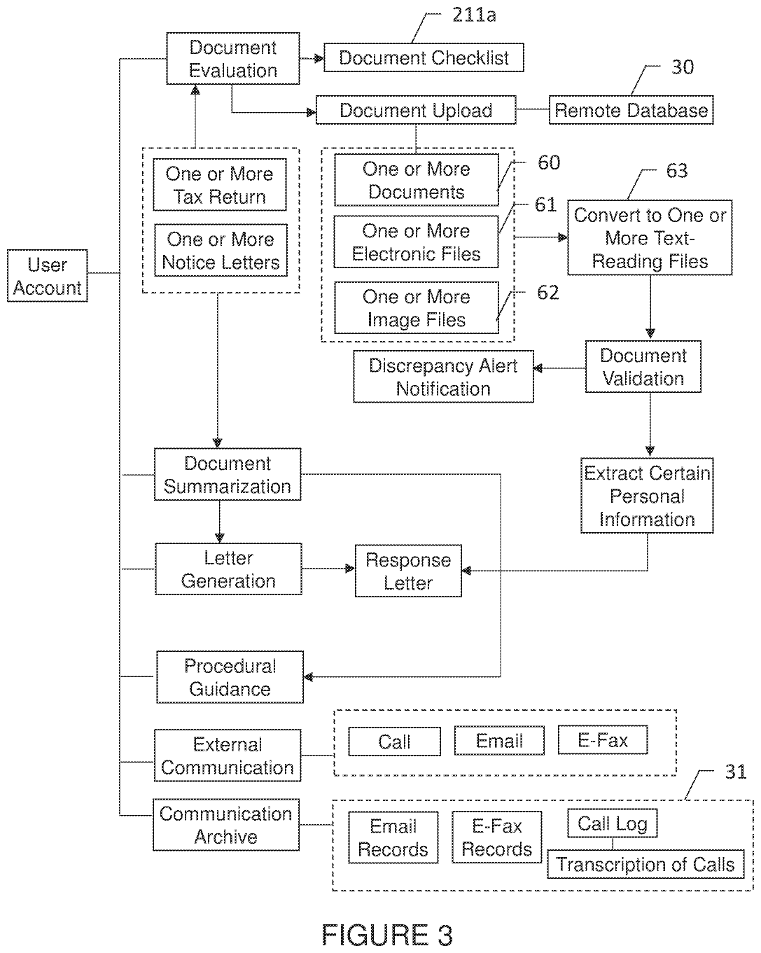

### NUMBERING REFERENCE

5—System for disseminating sensitive information
10—Software application
11—Mobile application
12—Web-based application
20—Artificial intelligence (AI) module
211—Document evaluation component
211a—Document checklist
212—Document validation component
213—Document summarization component
214—Letter generation component
215—Guidance component
216—Extraction component
21—External communication module
30—Remote database
31—Archive
40—Network
50—Mobile device
51—Camera
52—Touch screen
53—Mic
54—Speaker
55—Photo library
60—One or more documents
61—One or more electronic files
62—One or more image files
63—One or more text-readable files

### DETAILED DESCRIPTION OF THE EMBODIMENTS

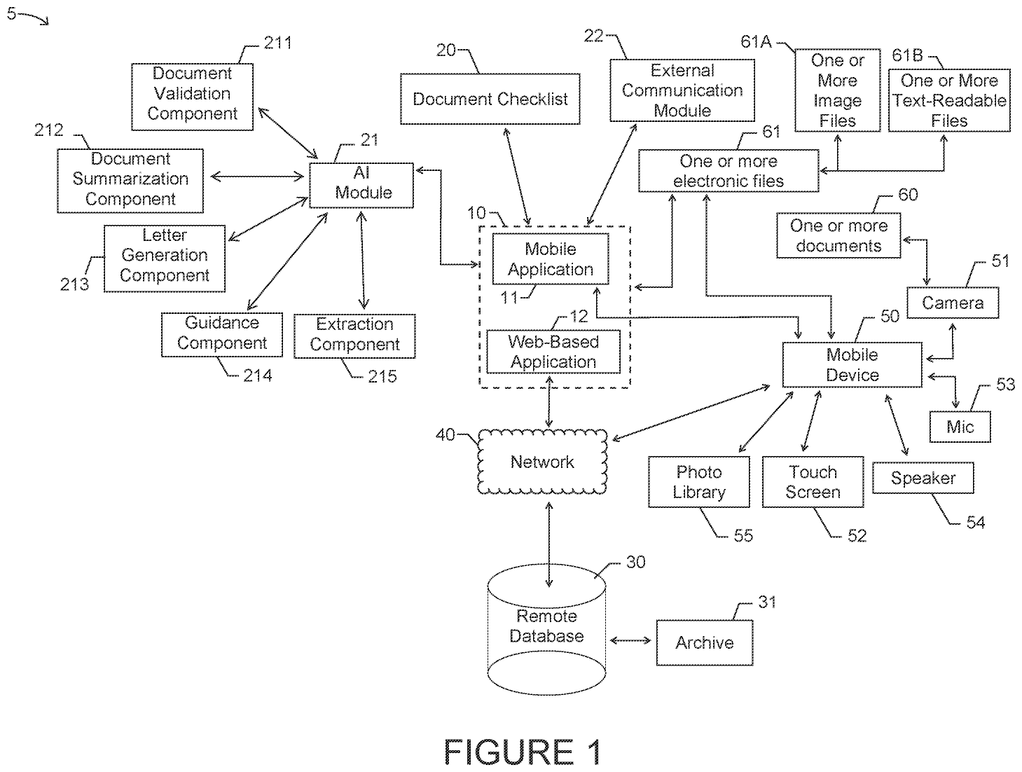

The present disclosure describes a system for disseminating sensitive information 5. As shown in FIG. 1, the system for disseminating sensitive information 5, hereinafter referred to as the “dissemination system” 5, includes a software application 10, a remote database 30, a network 40, a mobile device 50, and one or more documents 60. The software application 10 comprises a mobile application 11 and, optionally, a web-based application 12. The mobile device 50 is configured to wirelessly connect to the network 40 and provides a camera 51, a touch screen 52, a speaker 53, a mic 54, and a photo library 55. The software application 10 enables a user to efficiently compile, validate, and electronically transmit electronic copies of one or more documents 60, via email or electronic facsimile (E-Fax), to another party, such as, but not limited to, a corporate entity or a government agency, who may or may not be a user of the dissemination system 5. The one or more documents 60 include a combination of permanent documents, one or more temporary documents, one or more tax returns or one or more notice letters received from an auditing party.

The software application 10 provides a user account for each user. Each user must log into their user account with unique user credentials. User credentials preferably comprise a username and password. However, it is anticipated that user credentials could alternatively comprise biometric authentication. If the user accesses their respective user account on their mobile device 50, the mobile application 11 allows the user to access the camera 51, or the photo library 55, while the user is logged into their respective user account. The user may have a claimed dependent or claim one or more credits, which may include but not limit to dependent credit, self-employment credit, or any other tax credits.

The software application 10 comprises an artificial intelligence (AI) module 20, and an external communication module 21. The AI module 20 may further comprise a document evaluation component 211, a document validation component 212, a document summarization component 213, a letter generation component 214, a guidance component 215, and an extraction component 216.

The document evaluation component 211 may evaluate the one or more tax returns and the one or more notice letters, in response, the document evaluation component 211 determines a document checklist 211a. The document checklist 211a comprises a list of one or more documents 60 which includes permanent documents and temporary documents that the user will need to create electronic copies of and, subsequently, upload to the remote database 30.

In a nonlimiting, exemplary embodiment of the dissemination system 5 the software application 10 may prompt the user, after uploading electronic copies of two or more documents 60, to enter the physical street address where the user and claimed dependent reside. Upon the user providing such personal information, the document validation component 212 is configured to search for the personal information within two or more text-readable files 63 to confirm whether such personal information is consistently disclosed. It is anticipated that the document validation component 212 could be configured to automatically search a predetermined subset of the one or more text-readable files 63 or allow the user to manually select two or more files to cross-reference.

The permanent documents may include a social security card and a birth certificate for the user, or for both the user and the claimed dependent. Temporary documents may include one or more of the following: employment records of the claimed dependent, school records of the claimed dependent (such, but not limited to, as a 1098T form or a transcript), medical records of the claimed dependent, records related to the daycare provider of the claimed dependent, documents which establish proof of residency of the user (such as a utility bill, a mortgage note or a lease agreement), a letter from a religious institution verifying the user's relationship with the claimed dependent, a paternity test evidencing a paternal relationship between the user and the claimed dependent, a marriage certificate, adoption paperwork, Native American tribal documents, receipts, invoices, proof of income documents, bank statements, profit and loss statements, or mileage logs.

As an example, it is not uncommon for an audit to pertain to an individual's tax return, particularly if the individual claimed a dependency exemption on their tax return. In such an audit, the individual being audited typically must prove he or she lived with the dependent for more than half of the tax year, verify how he or she is related to the claimed dependent, as well as satisfaction of several other requirements established by the Internal Revenue Service (“IRS”). In another example, an audit for a self-employed individual or a professional that practices as a sole proprietor is often triggered when a discrepancy is found. The self-employed individual or professional typically needs to provide supporting documents to prove his or her income and expenses.

The mobile application 11 allows the user to access the camera 51 to capture one or more image files 62 of the one or more documents 60 and upload each of the one or more image files 62 to the remote database 30. Alternatively, if the user already has an electronic copy of one or more of the one or more documents 60, the software application 10 is configured to allow the user to select one or more locally stored electronic files 61 and upload the selected files to the remote database 30. The document checklist 211a is configured to display a visual icon adjacent to each document listed in the document checklist 211a to indicate whether an electronic copy of the particular document has been uploaded. Additionally, the document checklist 211a also includes descriptive information regarding each of the one or more documents 60. It is anticipated that the document checklist 211a may optionally provide one or more example files of each document enumerated in the document checklist 211a for the user to view for further clarification.

The software application 10 is configured to utilize an optical character recognition (OCR) process to create one or more text-readable files 63 of each electronic file uploaded to the remote database 30. Subsequently, the software application 10 is configured to utilize the document validation component 212 of the AI module 20 to search and cross-reference the one or more text-readable files 63 with one another to validate certain sensitive personal information, such as the residency of the user and dependent, is consistently disclosed within each of the one or more documents 60. The document validation component 212 may be configured to cross-reference the one or more text-readable files 63 for identifying information of more than one individual, which may pertain to certain circumstances, such as when the user is not the parent of the claimed dependent. The document validation component 212 is also configured to identify discrepancies amongst the one or more text-readable files 63. If a discrepancy is identified by the document validation component 212, the external communication module 21 is configured to subsequently send a discrepancy alert notification to the user.

The discrepancy alert notification may be configured to be electronically transmitted as a push notification on the mobile device 50, an email, or a text message. The discrepancy alert notification is configured to identify the certain personal information, such as but not limited to a physical street address, which the document validation component 212 cross-references in two or more of the text-readable files 63. It is further anticipated that the external communication feature 22 may be configured to not send an electronic facsimile when the document validation component 212 identifies one or more discrepancies related to certain personal information not being disclosed consistently in two or more electronic files 61 uploaded to the remote database 30.

Furthermore, in some circumstances, the one or more notice letters received by the users from the auditing party may be complex and overwhelming, especially involving deduction and credits, which can be challenging for an average person who is not familiar with tax terminology. The document summarization component 213 of the AI module 20 may be configured to identify the purpose of the one or more notice letters, and further summarize and interpret the one or more notice letters in plain language or using simpler terminology. In response to identifying the purpose of the one or more notice letter, the letter generation component 214 may generate a response letter and the guidance component 215 may be configured to generate procedural steps. The response letter may include a written description of the list, listing the one or more documents 60 submitted which are required by the auditing party. Additionally, the extraction component 216 may be configured to extract the certain personal information from the one or more text-readable files 63 and generate the certain personal information on the response letter.

In one aspect, where the auditing party requests supporting documents for his or her expenses. The extraction component 216 may be configured to extract one or more numbers from the one or more tax returns to create a target number. The extraction component 216 may also extract numbers from supporting documents, such as receipts or invoices. The document validation component 212 is configured to calculate if a sum of the receipts or invoices uploaded to the remote database 30 reaches the target number. For instance, the auditing party requests supporting documents for office supplies expenses, which is $3250 on the filed tax returned form, the document validation component 212 will verify if all the uploaded receipts sum up to the target number $3250. If a discrepancy is identified by the document validation component 211, the external communication module 21 is configured to subsequently send a discrepancy alert notification to the user.

The external communication module 21 allows the user to send one or more emails or electronic facsimiles (E-Fax) of one or more electronic copies of the one or more documents 60 to one or more other parties. The external communication module 21 allows the user to manually input an email address or fax number as well as select which files to electronically transmit in the email or E-Fax. However, it is anticipated that the external communication module 21 may optionally be configured to automatically provide a phone number, email address, or fax number for the user to call, email, or E-Fax, respectively. The external communication module 21 is further configured to transmit one or more reminder notifications to the user if one or more electronic copies of the one or more documents 60 have not been uploaded by a predetermined date.

The remote database 30 provides an archive 31 to electronically store prior external communication records, which may include email records, electronic facsimiles (E-Fax), or phone calls made from within the mobile application 11 It is further anticipated that phone call transcriptions of phone calls made using the external communication module 21 may be generated and saved within the archive 31. The remote database 30 may be configured to allow the user to also store other electronic files 61, such as the user's prior tax returns.

The present disclosure is further directed to a method for electronically compiling and transmitting one or more electronic copies of the one or more documents 60. Accordingly, the method comprises: creating a user account, accessing the user account on the mobile device 50 via the mobile application 11; utilizing the document evaluation component 211 of the AI module 20 to evaluate one or more tax returns and one or more notice letters received from another party; collecting hard copies of one or more documents 60 determined by the document evaluation component 211; selecting the document upload feature and utilizing the camera 51 to capture one or more image files 62 of the one or more documents 60 or, alternatively, importing the one or more image files 62 or other types electronic files 61 from the photo library 55; uploading the one or more electronic files 61 to the remote database 30; creating one or more text-readable files 63 from the one or more document 60 or the one or more electronic files 61; selecting the document validation component 212 of the AI module 20 and validating that certain sensitive personal information, which may include a name or address, contained in each of the one or more text-readable files 63 is consistent, selecting one or more of the one or more electronic files 61 to electrically fax or email via the external communication module 21, electronically transmitting one or more electronic files 61, calling the other party to confirm that the one or more electronic files 61 that were electronically transmitted were received.

The method may also comprise utilizing a document summarization component 213 of the AI module 20 to identify purpose of the notice letter and summarize the notice letter and automatically storing all records of communication within the archive 31; utilizing a letter generation component 214 of the AI module 20 to generate a response letter to the other party, utilizing an extraction component 216 of the AI module 20 to extract the certain personal information from the one or more text-readable files 63 and generate the certain personal information on the response letter, utilizing a guidance component 215 to generate procedural steps in response to identifying the purpose of one or more notice letters, and utilizing the extraction component 216 of the AI module 20 to extract one or more numbers from the one or more tax returns to create a target number; and utilizing the document validation component 212 to calculate if a sum of receipts uploaded to the remote database reaches the target number.

While the embodiments of the invention have been disclosed, certain modifications may be made by those skilled in the art to modify the invention without departing from the spirit of the invention.

1. A system for dissemination of sensitive information comprising:
a user;
wherein the user claims one or more credits;
a mobile device;
wherein the mobile device is configured to wirelessly connect to a network;
wherein the mobile device comprises a camera;
a remote database;
wherein the remote database is connected to the network;
one or more documents;
wherein the one or more documents comprise permanent documents, one or more temporary documents, one or more tax returns, and one or more notice letters received from another party;
a software application;
wherein the software application comprises an artificial intelligence (AI) module, and an external communication module;
wherein the artificial intelligence (AI) module further comprises a document evaluation component, a document validation component, and a document summarization component;
wherein the document evaluation component is configured to evaluate the one or more tax returns and the one or more notice letters;
in response to evaluating the one or more tax returns and the one or more notice letters, the document evaluation component is configured to determine a document checklist;
wherein the document checklist comprises a list of one or more documents;
wherein the document checklist is configured to display a visual indicator adjacent to each document to signify the status of the corresponding document;
wherein the document validation component is configured to cross-reference certain personal information in two or more documents uploaded to the remote database;
wherein the certain personal information comprises a physical street address of the user;
wherein the document validation component is configured to generate a discrepancy alert notification if the certain personal information in the two or more documents is inconsistent;
wherein the document summarization component is configured to identify purpose of the one or more notice letters;
in response to identifying the purpose, the document summarization component is configured to generate a summary for the one or more notice letters;
wherein the external communication module is configured to transmit an electronic facsimile of one or more electronic files stored in the remote database;
wherein the external communication module is configured to generate a receipt of delivery confirmation notification; and
wherein the external communication module is configured to send one or more reminder notifications to the user regarding when to upload one or more documents.

2. The system for dissemination of sensitive information of claim 1, wherein the AI module comprises a letter generation component configured to generate a response letter in response to identifying the purpose of one or more notice letters.

3. The system for dissemination of sensitive information of claim 2, wherein the response letter comprises a written description of the list of one or more documents.

4. The system for dissemination of sensitive information of claim 2, wherein the AI module comprises an extraction component configured to extract the certain personal information from the one or more documents and generate the certain personal information on the response letter.

5. The system for dissemination of sensitive information of claim 1, wherein the AI module further comprises a guidance component configured to generate procedural steps in response to identifying the purpose of one or more notice letters.

6. The system for dissemination of sensitive information of claim 1, wherein the permanent documents comprise a social security card and a birth certificate of the user.

7. The system for dissemination of sensitive information of claim 1, wherein the temporary documents comprise one or more utility bills of the user, a mortgage note, a lease agreement, a marriage certificate, one or more Native American tribal documents, or a combination thereof.

8. The system for dissemination of sensitive information of claim 1, wherein the user has a claimed dependent, and the one or more credits comprise dependent credit.

9. The system for dissemination of sensitive information of claim 8, wherein the permanent documents comprise a social security card and a birth certificate of both the user and the claimed dependent.

10. The system for dissemination of sensitive information of claim 8, wherein the temporary documents comprise employment records, school records, medical records, records related to daycare provider of the claimed dependent, a letter from a religious institution verifying the user's relationship with the claimed dependent, paternity test, adoption paperwork establishing a relationship between the user and the claimed dependent, or a combination thereof.

11. The system for dissemination of sensitive information of claim 1, wherein the one or more credits comprise self-employment credit.

12. The system for dissemination of sensitive information of claim 11, wherein the temporary documents comprise receipts, invoices, proof of income documents, bank statements, profit and loss statements, mileage logs, or a combination thereof.

13. The system for dissemination of sensitive information of claim 1, wherein the AI module comprises an extraction component configured to extract one or more numbers from the one or more tax returns to create a target number.

14. The system for dissemination of sensitive information of claim 13, wherein the document validation component is configured to calculate if a sum of receipts uploaded to the remote database reaches the target number.

15. A method of utilizing a system for dissemination of sensitive information wherein the method comprises:
providing the system as described in claim 1;
creating a user account, accessing the user account on a mobile device via a mobile application;
utilizing the document evaluation component of the AI module to evaluate one or more tax returns and one or more notice letters received from another party;
collecting hard copies of one or more documents determined by the document evaluation component;
selecting a document upload feature utilizing a camera to capture one or more image files of the one or more documents;
uploading the one or more documents to the remote database based on a document checklist determined by the document evaluation component;
converting the one or more documents into one or more text-readable electronic files;
utilizing the document validation component of the AI module to cross-reference certain sensitive personal information contained in each of the one or more text-readable electronic files;
utilizing the document summarization component of the AI module to identify the purpose of the one or more notice letters and summarize the one or more notice letters;
utilizing the external communication module to select the one or more electronic files uploaded to the remote database to be electronically transmitted to the other party; and
utilizing the external communication module to electronically transmitting the one or more electronic files via electronic fax.

16. The method of utilizing a system for dissemination of sensitive information of claim 15, wherein the method further comprises the external communication module automatically storing all records of communication within an archive.

17. The method of utilizing a system for dissemination of sensitive information of claim 15, wherein the method further comprises utilizing a letter generation component of the AI module to generate a response letter to the other party.

18. The method of utilizing a system for dissemination of sensitive information of claim 17, wherein the method further comprises utilizing an extraction component of the AI module to extract the certain personal information from the one or more electronic files and generate the certain personal information on the response letter.

19. The method of utilizing a system for dissemination of sensitive information of claim 15, wherein the method further comprises utilizing a guidance component to generate procedural steps in response to identifying the purpose of one or more notice letters.

20. The method of utilizing a system for dissemination of sensitive information of claim 18, wherein the method further comprises utilizing the extraction component of the AI module to extract one or more numbers from the one or more tax returns to create a target number; and utilizing the document validation component to calculate if a sum of receipts uploaded to the remote database reaches the target number.
